(19) United States
(12) Patent Application Publication
(10) Pub. No.: US 2013/0200008 A1
(43) Pub. Date: Aug. 8, 2013

(54) METHODS OF IMPROVING CHITOSAN FOR WATER PURIFICATION

(71) Applicant: WATER SECURITY CORPORATION, Sparks, NV (US)

(72) Inventors: Sivarooban Theivendran, Reno, NV (US); San Hein, Reno, NV (US); Marian Pettibone, Reno, NV (US); James J. Kubinec, Reno, NV (US)

(73) Assignee: WATER SECURITY CORPORATION, Sparks, NV (US)

(21) Appl. No.: 13/760,985

(22) Filed: Feb. 6, 2013

Related U.S. Application Data
(60) Provisional application No. 61/595,294, filed on Feb. 6, 2012.

(51) Int. Cl. C08B 37/00; C02F 1/68

(52) U.S. Cl. CPC C08B 37/00; C02F 1/68
USPC 210/752; 536/20; 210/199; 29/428

(57) ABSTRACT

Methods for preparing a chitosan-based material for use in a halogen water treatment system are described. Treating chitosan or chitin with a compound selected from the group consisting of an acid, a base, a mild halogenating solution and combinations thereof provides a chitosan-based material that displays reduced leakage of halide ion. Water treatment systems and methods for treating water comprising at least one contaminant are also described.

### CROSS REFERENCE TO RELATED APPLICATIONS

This application claims priority to U.S. Provisional application 61/595,294, filed on Feb. 6, 2012, the disclosure of which is incorporated herein in its entirety by this reference as if sully set forth herein.

### FIELD OF TECHNOLOGY

The present disclosure relates to methods for producing a chitosan-based material for use in halogen water purification systems. Other embodiments described in the present disclosure relate to water treatment systems for providing potable water which include the chitosan-based product.

### BACKGROUND

Over one billion people lack access to reliable and sufficient quantities of safe or potable drinking water. Waterborne contaminants pose a critical health risk to the general public, including vulnerable populations, such as children, the elderly, and those afflicted with disease, if not removed from drinking water. An estimated six million people die each year, half of which are children under 5 years of age, from contaminated drinking water. The U.S. Environmental Protection Agency Science Advisory Board considers contaminated drinking water one of the public's greatest health risks.

Many people rely on groundwater as their only source of water. Groundwater was believed to be relatively pure due to its percolation through the topsoil; however, research has shown that up to 50% of the active groundwater sites in the United States test positive for waterborne contaminants. Waterborne contaminants may include microorganisms, including viruses, such as enteroviruses, rotaviruses and other reoviruses, adenoviruses Norwalk-type agents, other microbes including fungi, bacteria, flagellates, amoebae, Cryptosporidium, Giardia, other protozoa, prions, proteins and nucleic acids, pesticides and other agrochemicals, including organic chemicals, inorganic chemicals, halogenated organic chemicals and other debris. Accordingly, the removal of waterborne contaminants may be necessary to provide potable drinking water for the general public; water for emergency use during natural disasters and terrorist attacks; water for recreational use, such as hiking and camping; and water for environments in which water must be recirculated, such as aircraft and spacecraft.

Practical and reliable water purification and filtration systems satisfying these requirements are not commercially available and/or not sufficiently developed. Therefore, more efficient water treatment systems are desirable.

### BRIEF DESCRIPTION

Various embodiments of the present disclosure relate to methods for producing a water purification material comprising a chitosan-based material that displays reduced halide ion release.

A first embodiment of the present disclosure provides a method for producing a water filtration/purification material comprising a chitosan-based material. The method comprises contacting chitosan or chitin with a compound selected from an acid, a base, a mild halogenating solution, or combination of any thereof to provide a chitosan-based material, wherein the chitosan-based material displays a reduced conversion of halogen (X₂) to halide ion (X⁻) compared to a conventional chitosan that has not been contacted with an acid, a base, a halogenating solution or combination of any thereof.

Other embodiments of the present disclosure provide a water treatment system for providing potable water, the system initially comprising: an inlet in fluid communication with an outlet; a halogen release system comprising a first halogen, wherein the halogen release system is intermediate the inlet and the outlet; and a chitosan-based material made by a method according to the various embodiments described herein, wherein the chitosan-based material is intermediate the halogen release system and the outlet.

Still other embodiments of the present disclosure provide methods for manufacturing a water treatment system comprising: contacting chitosan or chitin with a compound selected from an acid, a base, a mild halogenating solution, or combination of any thereof to provide a chitosan-based material, wherein the chitosan-based material displays a reduced conversion of halogen (X₂) to halide ion (X⁻) compared to a conventional chitosan that has not been contacted with an acid, a base, a halogenating solution or combination of any thereof and positioning the chitosan-based material intermediate a halogen release system and an outlet, wherein the halogen release system, the chitosan-based material and the outlet are in fluid communication.

Still further embodiments of the present disclosure provide methods for treating water comprising at least one contaminant comprising: flowing water sequentially through a halogen release system and a chitosan-based material made according to the methods described herein, wherein the water has a halide ion concentration of less than 3 ppm downstream from the chitosan-based material.

### DESCRIPTION OF THE DRAWINGS

The various embodiments described herein may be better understood by considering the following description in conjunction with the accompanying drawings.

FIGS. 1A-C include illustrations of several embodiments of the water treatment system described herein.

FIG. 2 illustrates one embodiment of a method for treating water comprising at least one contaminant.

FIG. 3 illustrates one embodiment of a method for manufacturing a water treatment system as described herein.

FIG. 4A illustrates the iodine (I₂) elution from 15 CC MCV and a chitosan-based material comprising 22 g chitosan treated with a 0.25% (wt) solution of citric acid compared to an MCV alone and MCV with untreated chitosan. FIG. 4B illustrates the iodide (I⁻) elution from 15 CC MCV and a chitosan-based material comprising 22 g chitosan treated with a 0.25% (wt) solution of citric acid compared to an MCV alone and MCV with untreated chitosan.

FIG. 5A illustrates the iodine (I₂) elution from 10 CC MCV and 10 CC MCV+22 g untreated chitin. FIG. 5B illustrates the iodide (I⁻) elution from 10 CC MCV and 10 CC MCV+22 g untreated chitin.

FIG. 6A illustrates the iodine (I₂) elution from 10 CC MCV and 10 CC MCV+22 g mildly deacetylated chitin prepared by varying NaOH concentrations (20%-50%) at 95° C. for 3 hours using a solid to liquid ratio at 1:10. FIG. 6B illustrates the iodide (I⁻) elution from 10 CC MCV and 10 CC MCV+22 g mildly deacetylated chitin prepared by varying NaOH concentrations (20%-50%) at 95° C. for 3 hours using a solid to liquid ratio at 1:10.

FIG. 7A illustrates the iodine (I₂) elution from 10 CC MCV and 22 g of commercially available chitosan from Marshall Marin Products, India (MM chitosan). FIG. 7B illustrates the iodide (I⁻) elution from 10 CC MCV and 22 g of commercially available chitosan from Marshall Marin Products, India (MM chitosan).

FIG. 8A illustrates the iodine (I₂) elution from 15 CC MCV and a chitosan-based material treated with a mild halogenation (TCCA) compared to an MCV alone and MCV with untreated chitosan. FIG. 8B illustrates the iodide (I⁻) elution from 15 CC MCV and a chitosan-based material treated with a mild halogenation (TCCA) compared to an MCV alone and MCV with untreated chitosan.

FIG. 9A illustrates the iodine (I₂) elution from 15 CC MCV and a chitosan-based material treated with a mild halogenation (Iodine) compared to an MCV alone and MCV with untreated chitosan. FIG. 9B illustrates the iodide (I⁻) elution from 15 CC MCV and a chitosan-based material treated with a mild halogenation (Iodine) compared to an MCV alone and MCV with untreated chitosan.

### DESCRIPTION OF CERTAIN EMBODIMENTS

As generally used herein, the terms “include” and “have” mean “comprising”. As generally used herein, the term “about” refers to an acceptable degree of error for the quantity measured, given the nature or precision of the measurements. Typical exemplary degrees of error may be within 20%, 10%, or 5% of a given value or range of values. Alternatively, and particularly in biological systems, the term “about” may mean values that are within an order of magnitude, potentially within 5-fold or 2-fold of a given value.

All numerical quantities stated herein are approximate unless stated otherwise, meaning that the term “about” may be inferred when not expressly stated. The numerical quantities disclosed herein are to be understood as not being strictly limited to the exact numerical values recited. Instead, unless stated otherwise, each numerical value is intended to mean both the recited value and a functionally equivalent range surrounding that value. At the very least, and not as an attempt to limit the application of the doctrine of equivalents to the scope of the claims, each numerical parameter should at least be construed in light of the number of reported significant digits and by applying ordinary rounding techniques. Notwithstanding the approximations of numerical quantities stated herein, the numerical quantities described in specific examples of actual measured values are reported as precisely as possible.

All numerical ranges stated herein include all sub-ranges subsumed therein. For example, a range of “1 to 10” is intended to include all sub-ranges between and including the recited minimum value of 1 and the recited maximum value of 10. Any maximum numerical limitation recited herein is intended to include all lower numerical limitations. Any minimum numerical limitation recited herein is intended to include all higher numerical limitations.

As used herein, the term “halogen” refers to elements for the group 17 column of the periodic table having a molecular formula of X₂, where X is one of F, Cl, Br, or I. Examples of halogens include Cl₂, Br₂ or I₂. Halogen producing compounds include compounds that release a halogen into aqueous systems. As used herein, the term “halide” refers to the anionic form of a halogen atom, represented by X. Examples of halide ions include Cl⁻, Br⁻ and I⁻.

As used herein, the term “chitin” refers to a polymer of β-1,4-(2-deoxy-2-acetamidoglucose) that may be extracted from the exoskeletons of insects and arthropods, such as crabs, lobsters and shrimps, and cell walls of fungi and yeast. As used herein, the term “chitosan” refers to derivative of chitin having a polymeric structure comprising 2-deoxy-2-acetamidoglucose monomers and 2-deoxy-2-aminoglucose monomers and typically comprises greater than 70% deacetylated 2-deoxy-2-aminoglucose monomer units. Chitosan may be formed from chitin by hydrolyzing a portion (i.e., greater than 70%) of the 2-deoxy-2-acetamidoglucose monomeric units to 2-deoxy-2-aminoglucose monomeric units. Chitosan may be fully or partially deacetylated chitin. Chitosan comprises a polymer backbone comprising hydroxyl groups and amine groups. Chitosan may be soluble in aqueous acidic (pH<6.0) solutions. As used herein, the term “partially deacetylated chitosan” or “partially deacetylated chitin” refer to a polymeric structure having 2-deoxy-2-acetamidoglucose monomers and 2-deoxy-2-aminoglucose monomers and having a percent deacetylated units as described herein, for example, from about 5% up to 70% deacetylated 2-deoxy-2-aminoglucose monomer units, or in some embodiments from about 5% to 60% deacetylated 2-deoxy-2-aminoglucose monomer units. As used herein, the term “chitosan-based material” refers to the product formed by contacting chitosan or chitin according to the methods described herein.

As used herein, the phrases “Log Removal” and “Log reduction value” refer to the Log₁₀ of the ratio of the level of contaminants (typically the number of microorganisms) in the influent to the level of contaminants (typically the number of microorganisms) in the effluent.

As used herein, “to reduce contaminants” and “reducing contaminants” refer to disarming one or more contaminants in the fluid, whether by physically or chemically killing, removing, reducing, or inactivating the contaminants or otherwise rendering the one or more contaminants harmless.

In the following description, certain details are set forth to provide a thorough understanding of various embodiments of the apparatuses and/or methods described herein. However, a person having ordinary skill in the art will understand that the various embodiments described herein may be practiced without these details. In other instances, well-known structures and methods associated with the apparatuses and/or methods described herein may not be shown or described in detail to avoid unnecessarily obscuring descriptions of the embodiments described herein.

This disclosure describes various features, aspects, and advantages of various embodiments of water treatment systems as well as methods of making and using the same. It is understood, however, that this disclosure embraces numerous alternative embodiments that may be accomplished by combining any of the various features, aspects, and advantages of the various embodiments described herein in any combination or sub-combination that one of ordinary skill in the art may find useful.

Any patent, publication, or other disclosure material, in whole or in part, recited herein is incorporated by reference herein but only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

As used herein, the term “anion exchange resin” refers to a polymeric resin having an insoluble matrix or support structure, normally in the form of beads, particles, particulates, or powder, fabricated from an organic polymer structure. The polymeric structure has active cationic sites incorporated into the structure. The anions can reversibly bind to these active sites. Suitable active cationic sites include chloride form strong base ion exchange resins, such as quaternary trialkylammonium sites (—NR₃⁺), dialkylammonium sites (—NHR₂⁺), alkylammonium sites (—NH₂R⁺), and ammonium sites (—NH₃⁺) as well as other cationic active sites. There are other types of quaternary ammonium resins with different and unique functional groups, but the primary commercially available resins are the strong base, quaternary ammonium resins using DVB as the crosslinking agent. Certain suitable resins of these are the “type I” (trimethylammonium) and “type II” (dimethylethanol ammonium) functional groups. Other available suitable anion exchange resins may include, but are not limited to, chemically analogous or similar ‘strong base’ resins with a positively charged functional site such as tertiary sulfonium, quaternary phosphonium and alkyl pyridinium containing anion exchange resins. One of skill in the art would understand that other strong base anion exchange resins currently available or developed in the future could be readily substituted for the resins described herein without departing from the scope and intent of the present disclosure.

As used herein, the term “iodinated resin” means a resin prepared by the method described in U.S. Ser. No. 13/760,570, to Theivendran et al, filed Feb. 6, 2013 and entitled Methods of Producing Iodinated Resins, the disclosure of which is incorporated by this reference. Iodinated resins are believed to have a different structure than the structure of conventional iodinated anion exchange resins. While not intending to be limited by any proposed structure, it is believed that the structure of iodinated resins comprise iodine (I₂) or iodine intermediate residues (such as HOI) on the surface of the resin material and/or in the pores of the resin material. It is believed that the majority of the iodine residues and iodine intermediate residues of the iodinated resins are not associated with an anionic iodide residue on a cationic site of the resin, such as in the form of a polyiodide residue, i.e., I₃⁻, I₅⁻, I₇⁻, etc., typical for a conventional iodinated ion exchange resin. In contrast to iodinated resins, iodinated anion exchange resins comprise these polyiodide residues, I₃⁻, I₅⁻, I₇⁻, etc., associated with a large portion of the ionic sites of the anion exchange resin.

Water treatment systems may be designed to include chitosan or chitosan derivatives. For example, systems comprising chitosan and chitosan derivatives are described in U.S. Ser. Nos. 13/053,939 to Theivendran et al. and 13/069,029 to Theivendran et al., the disclosures of each of which are incorporated herein by this reference.

A conventional water treatment system or device having a halogen release system, chitosan, and a halogen or halide scavenger barrier may suffer from halogen shortage and/or halide leakage. For example, in a system comprising an iodine release system, chitosan, and an optional iodide scavenger may suffer from iodine shortage or iodide leakage. Iodine shortage generally refers to the reduction of iodine (I₂) concentration in the water treatment system after extended use. Iodide leakage generally refers to concentration of iodide (I) in the effluent of the water treatment system. Without wishing to be bound to any particular theory, it is believed that organic residuals associated with the chitosan and/or water may reduce iodine to iodide during the water treatment process. As a result, the Log Removal values of conventional water treatment devices may be lower due to the lower amount of iodine available to reduce or react with microbial contaminants. In addition, higher amount of iodide in the effluent may saturate the iodine/iodide scavenger barrier and leak from conventional water treatment devices. Generally speaking, these may result in decreased decontamination of the water and/or treated water having an increased iodine/iodide content. The present disclosure provides methods for preparing a chitosan-based material that displays reduced halogen shortage and/or reduced halide leakage compared to certain conventional chitosan materials that are not treated according to the various methods described herein. In specific embodiments, the present disclosure provides a chitosan-based composition that reduces conversion of iodine (I₂) to iodide (I⁻) compared to conversion observed using conventional, untreated chitosan materials.

In certain embodiments, chitosan or chitin suitable for use in the various embodiments described herein may include raw material selected from the group consisting of chitin, chitin derivatives, chitosan, chitosan derivatives, and any combination thereof. Chitosan may be soluble in aqueous acidic (pH<6.0) solutions. The chitosan or chitin may have a molecular weight in the range of from 5,000 Daltons to two million Daltons, such as from 50,000 Daltons to one million Daltons, or such as from 100,000 Daltons to 900,000 Daltons. In various embodiments, the chitosan or chitin may have a molecular weight from 100,000 Daltons to one million Daltons.

The chitosan-based materials may be prepared as described herein to provide reduced halogen shortage and reduced halide leakage. Without intending to be limited by any theory, it is believed that conventional chitosan products may react with halogens in a water treatment system, for example, iodine, and convert the halogen to a halide ion. The conversion of halogen to halide ion by the conventional chitosan may also result in increased halide leakage, i.e., higher concentrations of halide ion in the treated water, downstream from the chitosan. In the case of increased halogen shortage, the halogen source in the water treatment system may have to be replaced or regenerated sooner and/or more frequently due to the loss of halogen concentration by the action of the conventional, untreated chitosan. In the case of halide leakage, downstream halogen scavenger materials may have to be replaced or regenerated sooner due to higher concentrations of halide ion in the treated water. The various embodiments of the present disclosure may address these issues by preparing a chitosan-based material that display reduced halogen to halide ion conversion compared to conventional chitosan materials that have not been treated according to the methods described herein.

In specific embodiments involving an iodine release system, the chitosan-based materials may provide reduced iodine (I₂) shortage and reduced iodide (F) leakage. The chitosan-based material may be prepared according to embodiments described herein. For example, one embodiment of the present disclosure provides a method for producing a water filtration/purification material comprising a chitosan-based material comprising: contacting chitosan or chitin with a compound selected from the group consisting of an acid, a base, a mild halogenating solution, and combinations of any thereof to provide a chitosan-based material.

According to certain embodiments, the chitosan or chitin starting material may be contacted with an acid or an aqueous solution of an acid. According to these embodiments, the chitosan or chitin may be contacted with an acid such as an organic acid or an inorganic acid. Suitable acids include those acids in which the chitosan or chitin are substantially insoluble or acids at concentrations where the chitosan or chitin are substantially insoluble. As used herein, the term “substantially insoluble” means about 10% or less of the chitosan or chitin dissolves or solubilizes in the acid solution. Suitable organic acids include, for example, mono or poly-carboxylic acids and sulfonic acids. Examples of suitable organic acids include, but are not limited to, citric acid, oxalic acid, ascorbic acid, tartaric acid, glutamic acid, acetic acid, succinic acid, carboxylic acids or hydroxy carboxylic acids having the formula R—(COOH)ₓ, and sulfonic acids having the formula R—(SO₃H)ₓ, where R is an organic scaffold having at least one carboxylic acid or sulfonic acid functional group, optionally at least one hydroxyl group, and x is an integer from 1-4. Suitable inorganic acids include but are not limited to hydrochloric acid, sulfuric acid, phosphoric acid, boric acid, and nitric acid. In one specific embodiment, the acid may comprise citric acid. The acids may be gaseous or in a solution with a solvent comprising water or an organic solvent. For example, in one embodiment the acid may comprise an aqueous solution comprising from about 0.05% to about 1.0% by weight of the acid. According to other embodiments, the acid may comprise an aqueous solution comprising about 0.1% to about 0.5% by weight.

Alternatively, the acid may be added in an amount where the weight ratio of chitosan or chitin to acid is from about 5:1 to about 50:1 by weight or even from about 8:1 to about 20:1 by weight. Depending on the strength of the acid and/or the concentration of the aqueous acidic solution, the chitosan or chitin may be mixed with small volumes (weak acids) or large volumes of acidic solution, for example from about 1:1 to about 1:100 volume ratio of chitosan or chitin to acidic solution.

In yet another embodiment, the amount of acid may be determined by the pH of the solution comprising water, the acid and the chitosan or chitin. For example, an aqueous suspension of certain chitosan compounds in deionized water may have an average pH of greater than 8, for example, up to a pH of about 10. According to certain embodiments, a sufficient amount of the acid is added to the aqueous solution so that the pH of the aqueous solution of the acid and the chitosan or chitin may be from about 6.0 to about 8.0, and in other embodiments having a pH ranging from about 6.5 to about 7.5. According to one embodiment, the aqueous solution of the acid may be formed prior to contacting the aqueous solution with the chitosan or chitin. For example, the chitosan or chitin may be added to the aqueous acidic solution at a temperature of from about 0° C. to about 50° C., or even from about 15° C. to about 35° C., for example at around room temperature. The suspension of the chitosan or chitin in the aqueous acid solution may be agitated, stirred, mixed, and/or tumbled for a time sufficient to fully treat the chitosan, for example from 30 minutes up to 10 hours or more. In one embodiment, the chitosan or chitin may be contacted with an aqueous solution of citric acid having a concentration of from about 0.1% to about 1.0% by weight or even from about 0.1% to about 0.5% by weight.

According to other embodiments, chitin may be contacted with a base under conditions suitable to undergo a mild deacetylation process on the chitin. Under the mild deacetylation conditions, at least a small portion of the acetamide functional groups at the 2-position of the β-1,4-(2-deoxy-2-acetamidoglucose) monomer units of the chitin may be deacetylated to form β-1,4-(2-deoxy-2-aminoglucose) units. In certain embodiments, from greater than 5% to about 100% of the acetamide functionality in the chitin may be deacetylated during the mild deacetylation process. In other embodiments, from about from greater than 5% to about 40% of the acetamide functionality in the chitin may be deacetylated, or even from greater than 5% to about 30% of the acetamide functionality in the chitin may be deacetylated. Other non-basic conditions to effect the mild deacetylation may also be used to provide the deacetylated chitin having from greater than 5 to about 40% deacetylation even from greater than 5% to about 30% deacetylation. The resulting “chitosan-based material” will comprise the mildly deacetylated chitin having the percent deacetylated acetamide functionality as described herein.

According to certain embodiments the mild deacetylation of the chitin may be accomplished using mild basic deacetylation for example using a base such as a hydroxide base such as an aqueous hydroxide solution. Suitable hydroxide bases include, but are not limited to alkali metal hydroxides and alkaline earth metal hydroxides. For example, in certain embodiments, the base may be an alkali metal hydroxide selected from the group consisting of LiOH, NaOH, and KOH. The mild deacetylation may also be accomplished by contacting the chitin with a base such as an alkoxide base, for example an alkali metal or alkaline earth metal salt of methoxide, ethoxide or the like. Mild acetylation processes using other bases, such as amine or metal amide bases, are also envisioned.

Appropriate mild deacetylation conditions may be selected by varying one or more of the base concentration, the deacetylation temperature, and the duration of the deacetylation reaction to result in a deacetylated chitin or chitosan product having greater than 5% and less than 40% deacetylation, such as described herein. Applicants have surprisingly discovered that a chitosan based material comprising deacetylated chitin, as described herein, may display significantly reduced conversion of halogen to halide ion compared to deacetylated chitin having greater than 40% deacetylation or even conventional chitosan. However, deacetylated chitin having greater than 40% deacetylation may also display reduced halogen to halide conversion when treated with an acid or a mild halogenating agent, as described herein, either prior to or after the deacetylation process.

In certain embodiments, the mild deacetylation process may comprise contacting the chitin with an aqueous solution of an alkali metal hydroxide, such as NaOH or KOH, having a concentration ranging from about 10% to about 50% by weight. The chitin may be contacted with the aqueous hydroxide solution at a temperature ranging from between −20° C. to about 150° C. In certain embodiment, the temperature may range from about 80° C. to about 150° C. and in other embodiments the temperature may range from about 90° C. to about 120° C. Contacting the chitin under the mild deacetylation conditions will be for a sufficient time to provide the desired percent of deacetylation, for example, for a time range of from between 0.5 hr to up to 10 days, or in other embodiments for a time of from about 0.5 hr to about 10 hr. One of skill in the art, reading and understanding the embodiments of this method will be able to determine the appropriate base concentration, reaction temperature, and reaction time to provide a chitosan-based material having the desired percent deacetylation according to the methods herein.

In other embodiments, the chitosan or chitin may be contacted in a mild halogenating process to produce the chitosan-based material. According to these embodiments, the chitosan or chitin may be contacted with a solution of a mild halogenating agent or even two or more halogenating agents. In one embodiment, the solution may comprise from about 0.05% to about 2.0 by weight of the halogenating agent. In another embodiment, the solution may comprise from about 0.05% to about 1.0% by weight of the halogenating agent, or in other embodiments, from about 0.05% to about 0.5% by weight of the halogenating agent, and in certain embodiments, from about 0.10% to 0.15% by weight of the halogenating agent. The halogenating agent may comprise any agent comprising a halogen, such as chlorine, bromine, and iodine, capable of donating a halogen atom. The halogenating agent may be at least one of chlorine, bromine, iodine, aqueous chlorine solutions, aqueous bromine solutions, aqueous iodine solutions, chlorine dioxide, sodium hypochlorite, calcium hypochlorite, sodium chlorite, sodium dichloroisocyanurate, trichloroisocyanuric acid (“TCCA”), N-chlorosuccinimide, sodium hypobromite, pyridinium bromide perbromide, N-bromosuccinimide, and chloramine-T, and tetraglycine hydroperiodide. In various embodiments, the halogenating agent may comprise a chlorinating agent, such as TCCA, to release chlorine when contacted with water. Other suitable halogenating agents will be readily apparent to those skilled in the art. In one specific embodiment, the mild halogenating process may comprise contacting the chitosan or chitin with an aqueous solution of TCCA.

According to certain embodiments, the methods described herein may comprise contacting the chitosan or chitin with two or more of an acid treatment, a basic treatment for a mild deacetylation process, or a halogenating solution for a mild halogenating process as described herein to provide the chitosan-based material. For example, chitin may be treated according to the acid treatment described herein followed by a mild deacetylation process. Alternatively the chitosan or chitin may be treated according to the acid treatment followed by the mild halogenating process described herein. In another embodiment, chitin may be treated according to the acid treatment, followed by the mild deacetylation and the mild halogenating process. In another embodiment, the chitosan or chitin may be treated according to the mild deacetylation followed by the mild halogenating process. The chitosan or chitin may be treated with the two or three processes in any order to provide the chitosan-based material.

According to various embodiments, the methods for producing the chitosan-base material by contacting the chitosan or chitin with an acid, a base and/or a mild halogenating solution may further comprise washing the chitosan-based material with at least one aqueous wash. For example, the chitosan-based material may be washed with deionized water from one to three times to remove excess acid, base, and/or halogenating solution from the chitosan-based material. In other embodiments, the chitosan-based material may be dried to produce a dry chitosan-based material. Drying may be accomplished by air drying at room temperature or drying in a drying oven. Drying may be accomplished at atmospheric pressure or at reduced pressure.

The chitosan-based material may have a mesh size of from about 5 to about 30 mesh, or in certain embodiments, the chitosan-based material may have a mesh size of from about 5 to about 20 mesh.

Other embodiments of the present disclosure provide for a water treatment system for providing potable water. The water treatment systems may generally comprise a water treatment device comprising at least one halogen release system comprising a first halogen and a chitosan-based material prepared according to the methods described herein. According to these embodiments, the halogen release system may be intermediate the inlet and the outlet and the chitosan-based material may be located intermediate the halogen release system and the outlet. In various embodiments, the water treatment system may comprise a water treatment device comprising at least one halogen release system, a chitosan-based material as described herein, and at least one scavenger barrier. In various embodiments, the water treatment system may comprise a point-of-use water treatment system comprising a halogen release system, a chitosan-based material as described herein, a halogen scavenger barrier, and/or granular activated carbon. In various embodiments, the point-of-use water treatment system may comprise a self-contained unit that may be used to treat water from untreated sources and/or a self-contained unit, such as a countertop, refrigerator or other unit, which may be used to treat tap water. Certain embodiments may specifically exclude municipal sewage and/or industrial wastewaters and runoff.

In certain embodiments, the water treatment system may comprise a halogen release system comprising one or more of halogenated resins, liquid halogens, gaseous halogens, halogen crystals, halogen compounds, and combinations thereof. In various embodiments, the halogen release system may generally comprise one or more of chlorinated anion exchange resins, iodinated anion exchange resins, brominated anion exchange resins, iodinated resins, chlorine, bromine, iodine, iodine crystals, chlorine tablets, trichloroisocyanuric acid (“TCCA”), chlorine dioxide, sodium hypochlorite, solid calcium hypochlorite, sodium chlorite, sodium dichloroisocyanurate, and tetraglycine hydroperiodide.

In certain embodiments, the halogen release system may comprise a halogenated anion exchange resin. The halogenated anion exchange resin may be selected from the group consisting of chlorinated anion exchange resins, brominated anion exchange resins, iodinated anion exchange resins, and combinations thereof. In various embodiments, the halogenated anion exchange resin may comprise a chlorinated anion exchange resin. In various embodiments, the halogenated resin may comprise an iodinated anion exchange resin. For example, in various embodiments, the iodinated anion exchange resin may comprise a Microbial Check Valve or MCV® Resin available from Water Security Corp., Sparks, Nev. The MCV® Resin may achieve a residual iodine ranging between 0.5-4.0 mg/L. The MCV® Resin may achieve a Log reduction value ≧6 for bacteria and a Log reduction value ≧4 for viruses in contaminated water. In other embodiments, the iodinated anion exchange resin may comprise a resin prepared by the methods described in U.S. Ser. No. 13/466,801 to Theivendran et al., fined May 8, 2012, the disclosure of which is incorporated by this reference. In various embodiments, the halogenated anion exchange resin may comprise a chlorinated anion exchange resin and an iodinated anion exchange resin. Halogenated anion exchange resins are generally described in U.S. Patent Application Pub. No. US 2008/0011662 to Milosavljevic et al. In other embodiments, the halogen release system may be an iodinated resin, such as, an iodinated resin as described in U.S. Ser. No. 13/760,570, to Theivendran et al., filed Feb. 6, 2013, entitled Methods of Producing Iodinated Resins.

Water treatment systems described herein display a reduced halogen to halide conversion and/or a reduced excess halide ion leakage compared to a water treatment system that does not include the chitosan-based material. For example, in embodiments of the water treatment systems which comprise an iodinated anion exchange resin or iodinated resin and the chitosan-based material as described herein, the system will display a reduced halogen shortage and/or a reduced halide ion leakage compared to an equivalent water treatment system comprising an iodinated anion exchange resin or iodinated resin and untreated chitosan or chitin or conventional chitosan or chitin materials. It is believed that treatment of the chitosan or chitin according to the methods described herein results in a chitosan-based material that has a lower conversion of halogen, such as iodine, to halide ion, such as iodide. Thus, water treatment systems as described herein can provide advantages over conventional halogenated water treatment systems, including water treatment systems which include conventional chitosan or chitin materials. In specific embodiments, the water treated by the water treatment systems described herein may display a halide ion concentration of less than 3 ppm downstream from the chitosan-based material.

In various embodiments, the chitosan-based materials may reduce and/or eliminate any organic residuals in the chitosan or chitin to improve the Log reduction value of the water treatment system relative to a corresponding water treatment system having untreated chitosan or chitin. According to certain embodiments, the chitosan-based materials may reduce and/or eliminate iodide leakage.

According to certain embodiments, the chitosan-based materials may reduce iodide shortage. According to certain embodiments, the chitosan-based materials may increase the availability of iodine by oxidizing iodide to iodine.

In various embodiments, the water treatment system may comprise at least one scavenger barrier to adsorb or absorb halogens, and/or react with or provide catalytic reaction sites for halogens to convert the halogens to an ionic form. In certain embodiment, the scavenger barrier may be selected from the group consisting of carbon, such as activated carbon, and an ion exchange resin, such as a strong-base anion exchange resin. Activated carbon may comprise any suitable form, such as, for example, carbon pellets, carbon powder, and granular carbon. In various embodiments, the scavenger barrier may comprise granular activated carbon (“GAC”). In various embodiments, the scavenger barrier may comprise a halogen scavenger barrier, such as, for example, an iodine scavenger resin, a chlorine scavenger resin, and a bromine scavenger resin. In various embodiments, the scavenger barrier may comprise strong-base anion exchange resins, such as, for example, IODOSORB®, available from Water Security Corporation, Sparks, Nev., as described in U.S. Pat. No. 5,624,567. Briefly, IODOSORB®, sometimes referred to as an iodine scavenger resin, comprises trialkyl amine groups each comprising alkyl groups containing 3 to 8 carbon atoms which is capable of removing halogens, including iodine or iodide, from aqueous solutions. In various embodiments, the scavenger barrier may comprise a halogen scavenger barrier and GAC, wherein the GAC is intermediate the halogen scavenger barrier and the outlet.

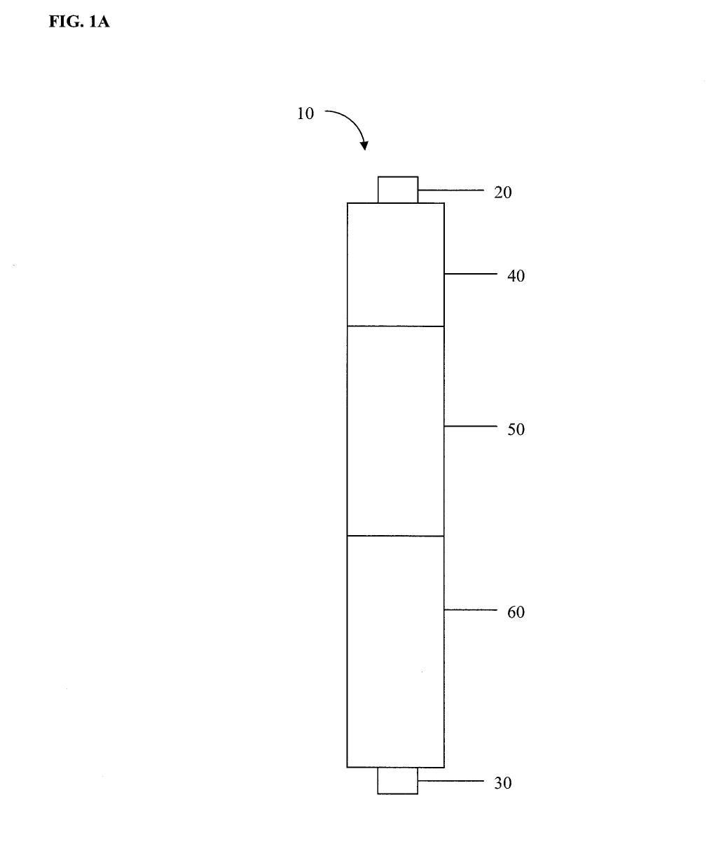

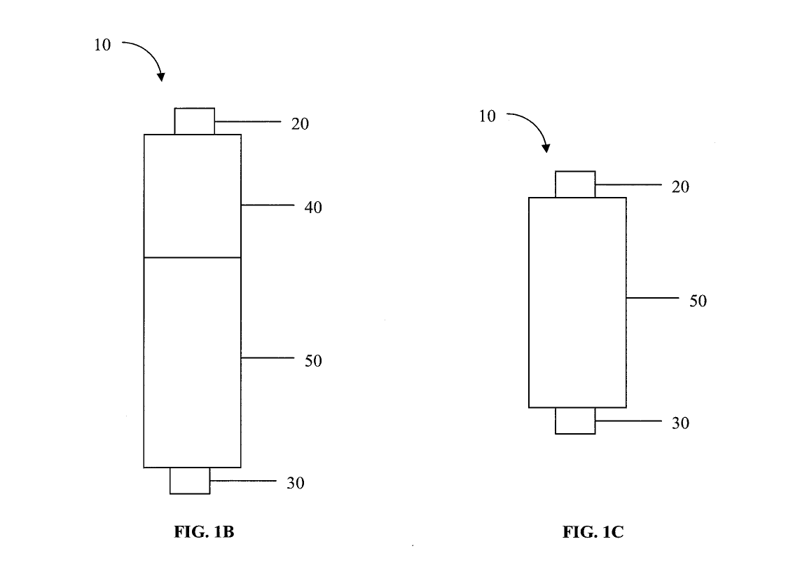

Referring to FIGS. 1A-B, in various embodiments, a water treatment system to provide potable water comprising water treatment device 10 may generally comprise an inlet 20 in fluid communication with an outlet 30, a halogen release system 40 intermediate the inlet 20 and the outlet 30, a chitosan-based material 50 intermediate the halogen release system 40 and the outlet 30; and, optionally, a scavenger barrier 60 intermediate the halogenated chitosan 50 and the outlet 30. Referring to FIG. 1C, in certain embodiments, the water treatment system comprising a water treatment device 10 may generally consist of an inlet 20 in fluid communication with an outlet 30, and a halogenated chitosan 50 intermediate the inlet 20 and the outlet 30. In various embodiments, the halogen release system 40 may comprise an iodinated anion exchange resin, such as an MCV® Resin, an iodinated anion exchange resin as described in U.S. Ser. No. 13/466,801, or an iodinated resin as described in U.S. Ser. No. 13/760,570, the chitosan-based material 50 may comprise chitosan or chitin that has been contacted with one or more of an acid, a base for a deacetylation process, and a mild halogenating agent, and the scavenger barrier 60 may comprise an ion exchange resin, such as IODOSORB®, and/or GAC.

In certain embodiments, the volume of the halogen release system may be less than or equal to the volume of at least one of the chitosan-based material and/or scavenger barrier. In various embodiments, the ratio of the halogen release system to the chitosan-based material, by volume, may be from 1:1 to 1:1000 and in other embodiments, the ratio of the halogen release system to the chitosan-based material, by volume, may be from 1:18 to 1:36. In various embodiments, the ratio of the halogen release system to the chitosan-based material, by volume, may be 1:36. In various embodiments, the ratio of the halogen release system to the chitosan-based material, by volume, may be from 1:1 to 1:1000, and a ratio of the halogen release system to the scavenger barrier, by volume, may be from 1:1 to 1:10. In various embodiments, the ratio of the halogen release system to the chitosan-based material, by volume, may be from 1:18 to 1:36, and a ratio of the halogen release system to the scavenger barrier, by volume, may be 1:5. In various embodiments, the volume of the iodinated anion exchange resin may be 15 cc, the volume of the chitosan-based material may be 22 cc and the volume of the ion exchange resin may by 120 cc.

In certain embodiments, the water treatment system may comprise a housing (not shown). The housing may comprise a longitudinal axis along the z-axis wherein at least one of the inlet, outlet, halogen release system, chitosan-based material, and scavenger barrier, may be axially aligned along the longitudinal axis. The direction of fluid flow may be from the inlet towards the outlet along the longitudinal axis. The housing may comprise any suitable material, such as, for example, but not limited to, glass, metal, ceramic, plastic, and any combination thereof. In at least one embodiment, the housing material may not be permeable or soluble to aqueous and/or non-aqueous liquids. The housing may comprise any suitable shape, such as, for example, but not limited to, a polyhedron, a non-polyhedron, and any combination thereof. In at least one embodiment, the housing may comprise a generally cylindrical shape.

Referring to FIG. 3, one embodiment of a method for manufacturing a water treatment system is presented. According to this embodiment, a method of manufacturing a water treatment system comprising a chitosan-based material is described. In these embodiments, the method for manufacturing the water treatment system may comprise producing a chitosan-based material according to any of the embodiments described herein, and positioning the chitosan-based material intermediate a halogen release system and an outlet, wherein the halogen release system, the chitosan-based material, and the outlet are in fluid communication. In one embodiment, producing the chitosan-based material may comprise contacting chitosan or chitin with a compound selected from the group consisting of an acid, a base, a mild halogenating solution, and combinations of any thereof, to provide a chitosan-based material, wherein the chitosan-based material displays a reduced conversion of halogen (X₂) to halide ion (X⁻) compared to a chitosan or chitin that has not been treated with an acid, a base, and/or a mild halogenating solutions. In various embodiments, the water treatment system may comprise at least one scavenger barrier, and positioning the at least one scavenger barrier intermediate the halogenated chitosan and the outlet. In various embodiments, the water treatment system may comprise an ion exchange resin and GAC, and positioning the ion exchange resin intermediate the halogenated chitosan and the outlet, and positioning the GAC intermediate the ion exchange resin and the outlet.

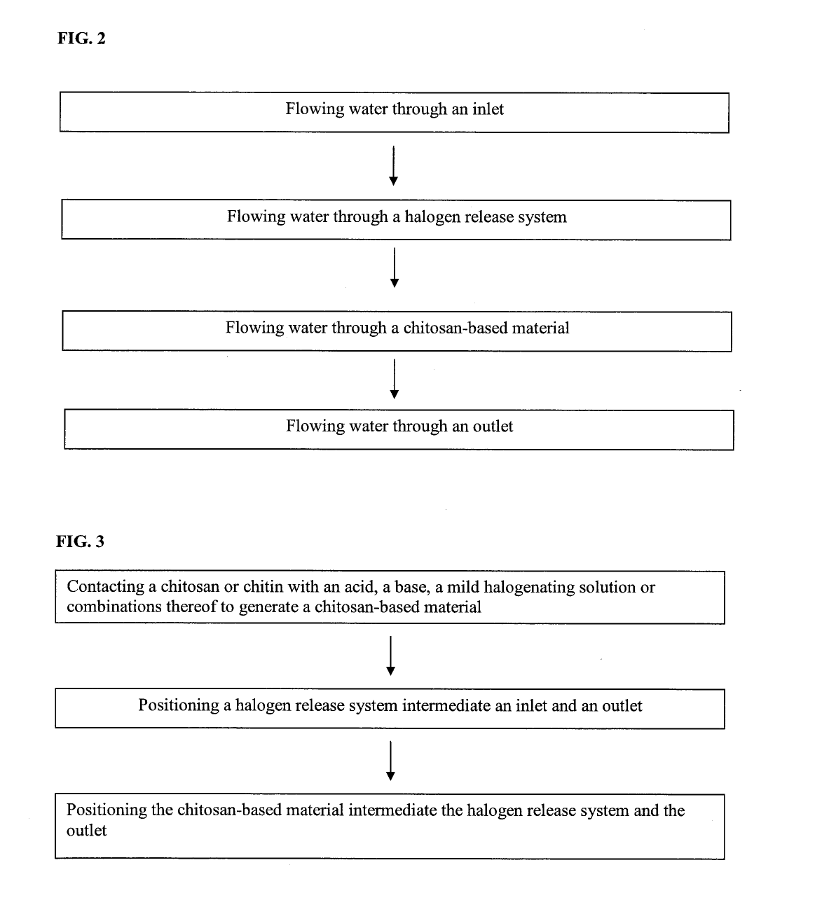

Referring to FIG. 2, in certain embodiments, a method of treating water comprising at least one contaminant by a water treatment system comprising an inlet in fluid communication with an outlet, a halogen release system comprising a first halogen, wherein the halogen release system is intermediate the inlet and the outlet, a chitosan-based material prepared according to a method as described herein, wherein the chitosan-based material is intermediate the halogen release system and the outlet, and, optionally, a scavenger barrier intermediate the halogenated chitosan and the outlet, the method may generally comprise flowing the water sequentially through the halogen release system, the chitosan-based material, and the optional scavenger barrier, wherein the water has a halide ion concentration of less than 3 ppm downstream from the chitosan-based material. The halogen release system may be any of the halogen release systems described herein, including an MCV® Resin. The chitosan-based material may be any of the materials prepared by the methods described herein. The scavenger barrier may be any of the scavenger barriers described herein, including IODOSORB®, and/or GAC. In various embodiments, the effluent from a water treatment system may be at least one of free, substantially, or completely free from iodine, iodide, chloride, and/or chlorine. As used herein, the term “substantially free” means that the material is present, if at all, as an incidental impurity. As used herein, the term “completely free” means the material is not present at all.

According to certain embodiments, the treated water may display a viral Log reduction value of at least 4 and a bacterial Log reduction value of at least 6. These values may be observed at generally operating temperatures and pH, for example at temperatures of at least 4° C. and at a pH value of at least 5. Viral and bacterial contaminants that can be effectively removed from the treated water include, but are not limited to, viruses, such as enteroviruses, rotaviruses and other reoviruses, adenoviruses, Norwalk-type agents, other microbes including fungi, bacteria, flagellates, amoebae, Cryptosporidium, Giardia, and other protozoa.

In certain embodiments, the chitosan-based material may have an empty bed contact time (“EBCT”) of greater than 1 second. The EBCT is the volume of the chitosan-based material divided by the flow rate. In at least one embodiment, the EBCT may be between 1 second and 120 seconds, such as between 15 seconds and 60 seconds and between 30 seconds and 60 seconds. In certain embodiments, the EBCT of chitosan-based material is 30 seconds to 120 seconds. In at least one embodiment, the EBCT of chitosan-based material is 120 seconds.

In certain embodiments, the fluid contacting the chitosan-based material may have a fluid velocity less than 0.5 cm/s. In at least one embodiment, the fluid velocity may be between 0.3 cm/s and 0.5 cm/s. In at least one embodiment, the fluid velocity may be less than 0.3 cm/s. In at least one embodiment, the fluid velocity may be between 0.15 cm/s and 0.24 cm/s. In at least one embodiment, the fluid velocity may be less than 0.15 cm/s. In at least one embodiment, the fluid velocity may be greater than 0.5 cm/s.

### EXAMPLES

The various embodiments described herein may be better understood when read in conjunction with the following representative examples. The following examples are included for purposes of illustration and not limitation. As generally used herein, the terms “ND” refers to not detectable or below the detection limit and “NA” refers to not applicable

Analytical grade chitin was obtained from Sigma Aldrich, St. Louis, Mo., (product number C9213). Industrial grade chitosan was obtained from Marshall Marine Products, No 1 Cholan Street, Erode, India. Citric Acid monohydrate (Certified ACS granular) was obtained from Fisher Scientific. The TCCA was obtained from Acros Organics, Fair Lawn, N.J., having 99% trichloroisocyanuric acid, molecular weight of 232.41 g, and solubility in water of 12 g/L.

### Example 1

In this example chitosan was treated with a mild acid and the resulting chitosan-based material was placed in a water treatment system with an MCV iodinated anion exchange resin. The iodine and iodide values were compared with those observed with untreated chitosan and an MCV resin without a chitosan-based material.

Citric acid (1.875 g) was added to deionized water (750 mL) in a 1 L bottle and the solution was mixed thoroughly to form a 0.25% (wt) aqueous solution of citric acid. To this solution was added 22 g of chitosan and the resulting suspension was gently mixed or tumbled for 4 hours. The solid:liquid ratio of chitosan to citric acid solution may be adjusted in accordance with process feasibility. However, the treatment ratio of chitosan to citric acid was maintained at 22 g chitosan to 1.875 g citric acid. It is preferred that the chitosan is introduced to a uniform citric acid solution to ensure complete exposure of the chitosan to the citric acid. The pH of the 22 g of chitosan in 750 mL deionized water without citric acid was 9.68. The average pH of the solution was measured during the mixing and is presented in Table 1. The liquid was removed and remaining solid was washed three times with 1 L volumes of deionized water. The chitosan-based material was dried at 60° C. for 80 minutes in a commercial dryer.

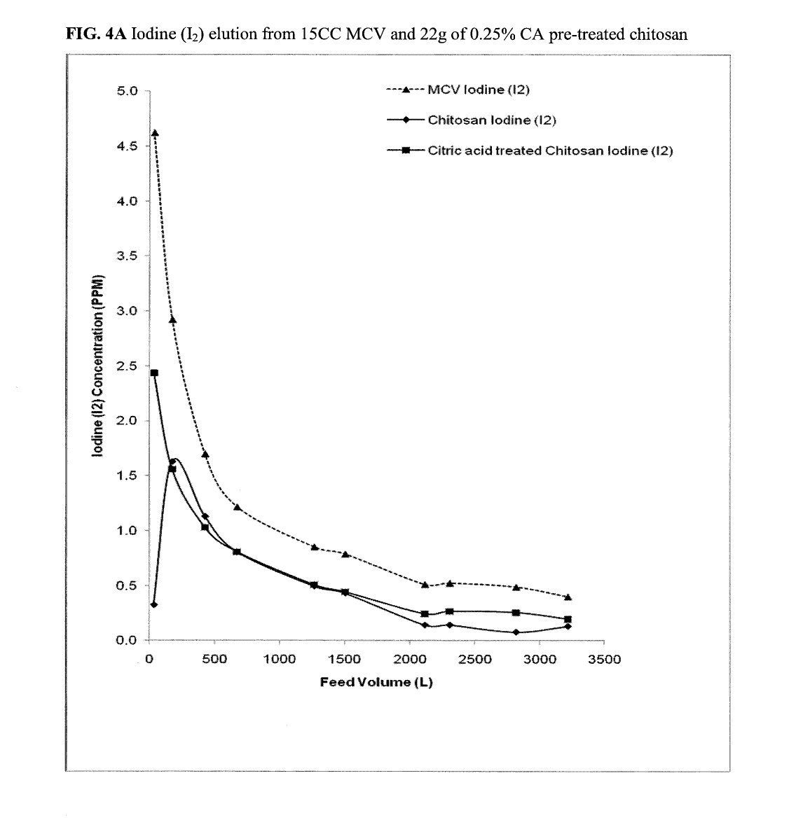

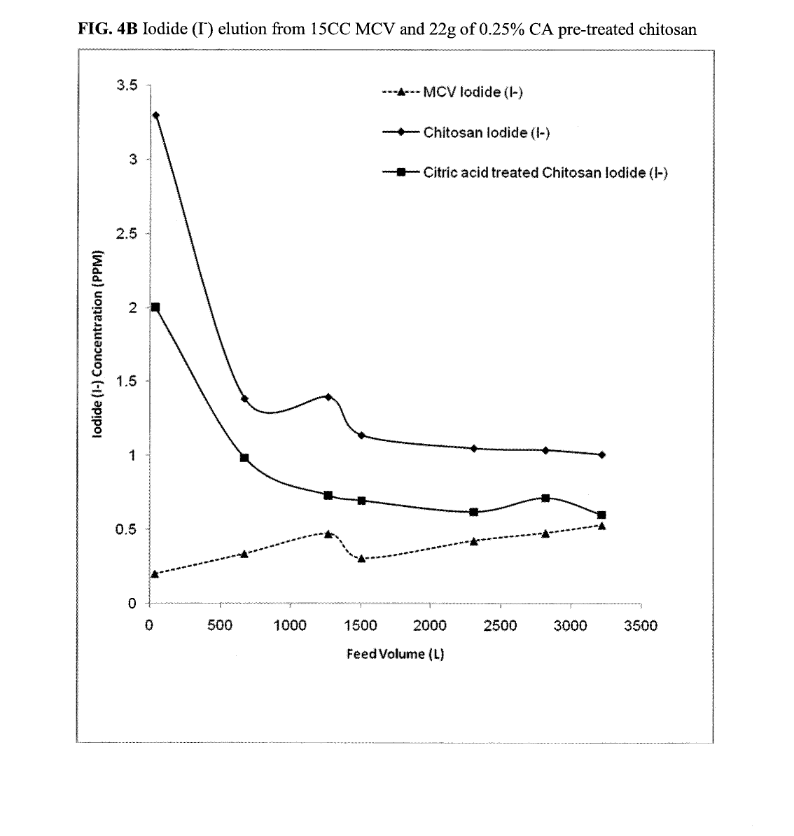

The results of an iodine (I₂)/iodide (I⁻) experiment of a water treatment system comprising i) MCV® Resin, ii) MCV® Resin and untreated chitosan and iii) MCV® Resin and the chitosan treated with citric acid are shown in FIG. 4. FIG. 4A presents the I₂ values (ppm) as a function of feed volume (L) and FIG. 4B presents the I⁻ values (ppm) as a function of feed volume (L). The volume of MCV® Resin was 15 cc, the mass of chitosan or treated chitosan was 22 grams. The flow rate was 160 mL/min. The iodine was measured by the leuco-crystal violet method 4500-I B and the iodide was measured by the leuco-crystal violet method 4500-I⁻ B as described in “Standard Methods for the Examination of Water and Wastewater”, American Water Works Association, 21^{st} edition (2005), pp. 4-95 and 4-98.

TABLE 1
pH of Chitosan/Citric Acid Solution during Mixing

| | 0.25% CA 4 h Citric Acid (CA) |
|---|---|
| Tumbling time (h) | Pre- treatment to Chitosan |
| 0.5 | 6.88 |
| 1.0 | 6.95 |
| 1.5 | 7.05 |
| 2.0 | 6.89 |
| 2.5 | 6.93 |
| 3.0 | 6.93 |
| 3.5 | 6.93 |
| 4.0 | 6.93 |
| 4.5 | 6.97 |
| 5.0 | 6.92 |
| 5.5 | 6.97 |
| 6.0 | 6.98 |

### Example 2

In this example chitin was treated with a mild deacetylation process and the resulting chitosan-based material was placed in a water treatment system with an MCV® iodinated anion exchange resin. The iodine and iodide concentration values were compared with those observed with untreated chitin, MCV® resin without a chitosan-based material, and commercially available chitosan. The iodine concentration was measured by the leuco-crystal violet method 4500-I B and the iodide concentration was measured by the leuco-crystal violet method 4500-I⁻ B as described in “Standard Methods for the Examination of Water and Wastewater”, American Water Works Association, 21^{st} edition (2005), pp. 4-95 and 4-98.

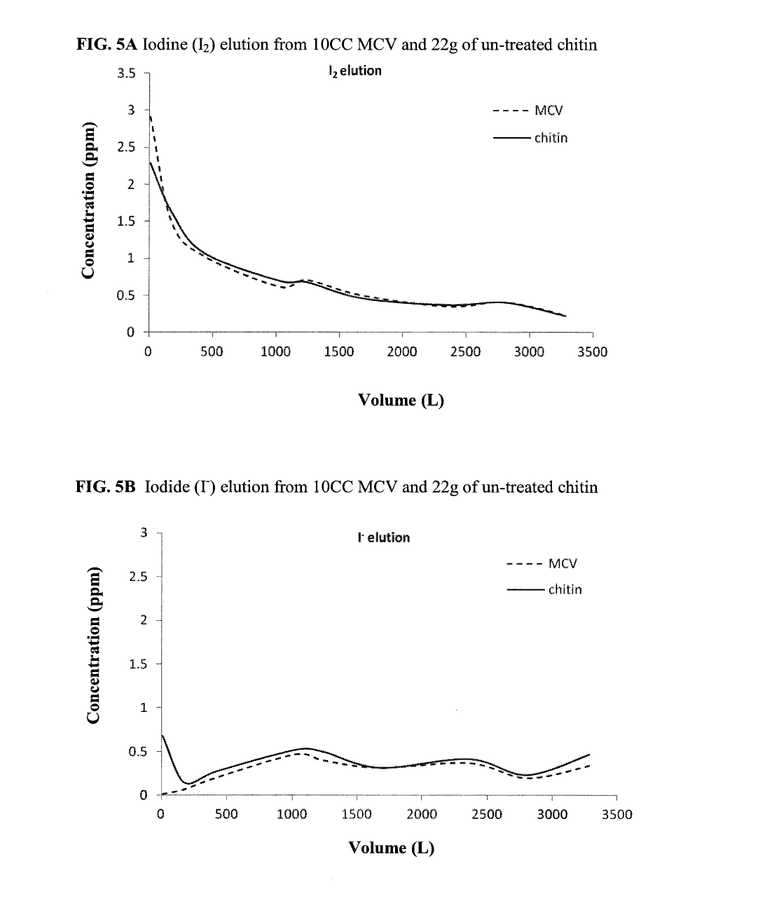

I) Untreated chitin does not change the release pattern of an MCV® iodinated anion exchange resin as shown in FIG. 5A-B. However, using chitin instead of chitosan could not be very effective against MS2 phage because chitin has much lower number of protonatable amine groups. In this example, partially deacetylated chitin was prepared and the iodine and iodide values analyzed. The results of an iodine (I₂)/iodide (I⁻) experiment of a water treatment system comprising i) MCV® Resin and ii) MCV® Resin and untreated chitin are shown in FIG. 5. FIG. 5A presents the I₂ values (ppm) as a function of feed volume (L) and FIG. 5B presents the I⁻ values (ppm) as a function of feed volume (L). The volume of MCV® Resin was 10 cc, the mass of chitin was 22 grams. The flow rate was 160 mL/min.

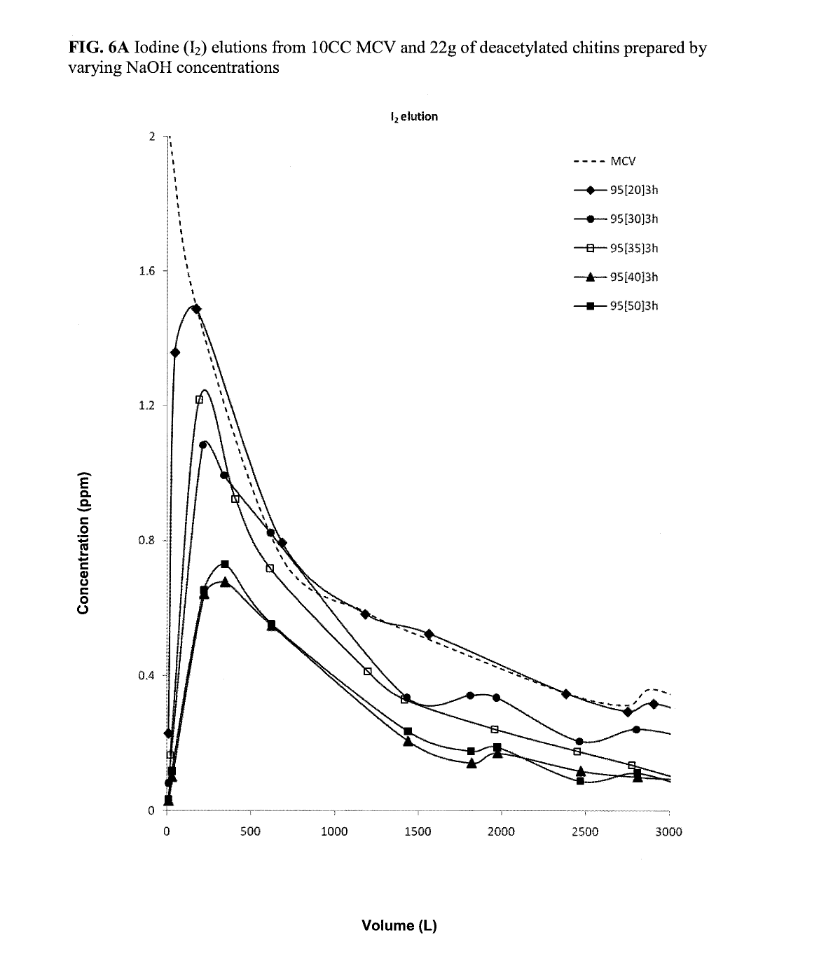

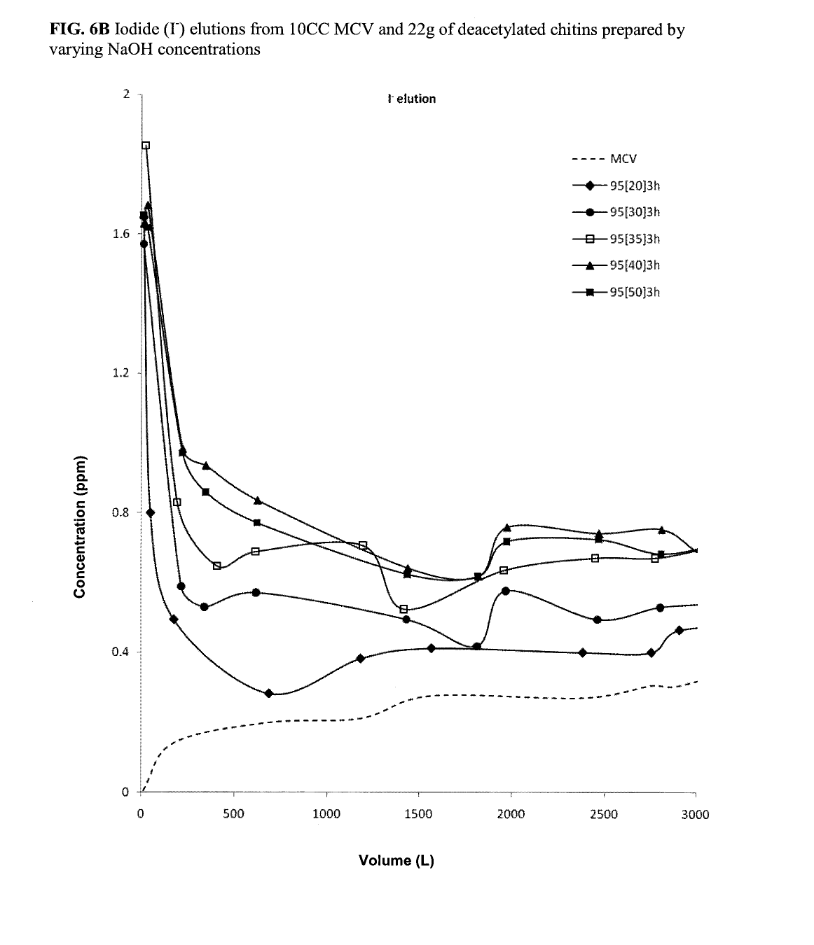

II) Chitin was deacetylated by varying NaOH concentrations (20, 30, 35, 40 and 50% w/w) at 95° C. for 3 hours using solid to liquid ratio at 1:10. After the deacetylation, the resultant deacetylated chitins were washed with water and dried around 60° C. for 80 min in a commercial clothes dryer. The deacetylated chitins were evaluated for the release of iodine and iodide in an iodinated anion exchange resin based water disinfection system. The results of an iodine (I₂)/iodide (I⁻) experiment of a water treatment system comprising i) MCV® Resin and ii) MCV® Resin and the five deacetylated chitins are shown in FIG. 6. FIG. 6A presents the I₂ values (ppm) as a function of feed volume (L) and FIG. 6B presents the I⁻ values (ppm) as a function of feed volume (L). The volume of MCV® Resin was 10 cc, the weight of deacetylated chitins were 22 grams. The flow rate was 160 mL/min.

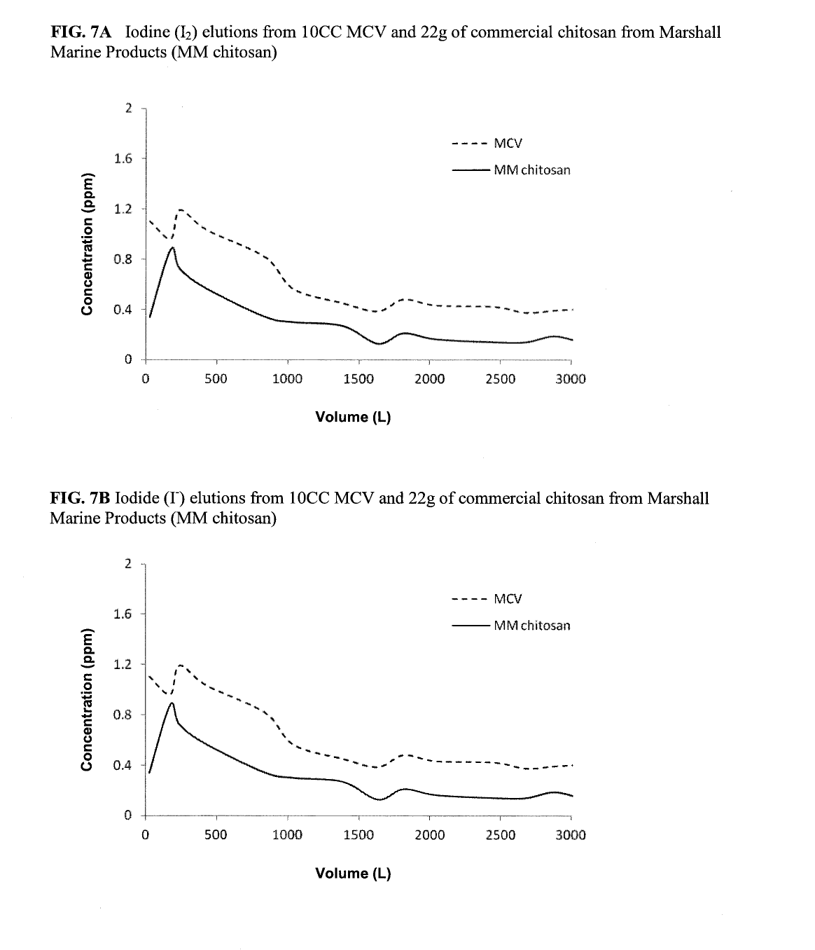

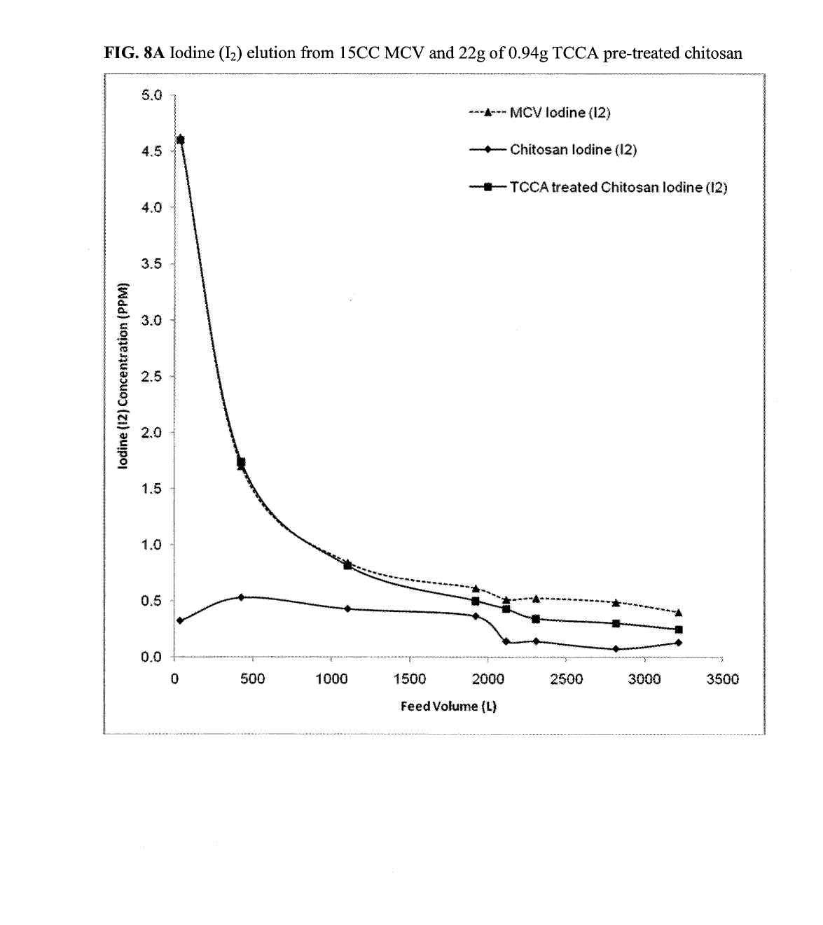

III) In a comparison system, untreated commercially available chitosan having 93.0% deacetylation was purchased from Marshall Marine Products, India. The commercial chitosan was evaluated for the release of iodine and iodide in an iodinated anion exchange resin based water disinfection system. The results of an iodine (I₂)/iodide (I⁻) experiment of a water treatment system comprising i) MCV® Resin and ii) MCV® Resin and the commercial chitosan are shown in FIG. 7. FIG. 7A presents the I₂ values (ppm) as a function of feed volume (L) and FIG. 7B presents the I⁻ values (ppm) as a function of feed volume (L). The volume of MCV® Resin was 10 cc, the weight of commercial chitosan was 22 grams. The flow rate was 160 mL/min. The results of the comparison display increased iodide release compared to those observed in FIG. 6B under milder deacetylation conditions using 20, 30 and 35% (w/w) NaOH.

Although the use of these partially deacetylated chitin products was further subjected to a satisfactory water disinfection performance in an iodinated anion exchange resin system, the chitin products from the milder deacetylation conditions displayed lower amounts of iodide release compared to conventional chitosan products in an iodinated anion exchange resin based system. The iodide ratio of the samples compared to MCV® resin until 3000 L were compared and the results are presented in Table 2. This table shows that for the milder the conditions of deacetylation, the analysis showed a closer amount of iodide released was between the system with iodinated anion exchange resin alone and the system with resin and deacetylated chitin. The MS2 phase kills contributed by commercial chitosan, 95[30]3h and 95[20]3h deacetylated chitins at feed volume around 2000 L are 1.6, 1.5 and 1.0 respectively. But, both 95[30]3h and 95[20]3h partially deacetylated chitins show lower iodide ratios compared to that of commercial chitosan from Marshall Marine Products, India.

TABLE 2
Iodide Ratio

| Sample | Degree of Deacetylation | Iodide ratio of Sample to MCV |
|---|---|---|
| chitin | 11.7 | $\frac{1.11}{0.93} = 1.19$ |
| 95[20]3h | 31.4 | $\frac{1.25}{0.72} = 1.74$ |
| 95[30]3h | 42.4 | $\frac{1.66}{0.82} = 2.02$ |
| 95[35]3h | 55.7 | $\frac{2.16}{0.88} = 2.46$ |
| 95[40]3h | 78.6 | $\frac{2.42}{0.82} = 2.95$ |
| 95[50]3h | 79.5 | $\frac{2.32}{0.78} = 2.97$ |
| Commercial chitosan | 93.0 | $\frac{3.01}{0.95} = 3.17$ |

95 = temperature of deacetylation (° C.)
[xx] = concentration of NaOH (w/w) used for deacetylation
x h = duration of deacetylation (hour)
iodide ratio = amount of iodide released by the system with resin and chitin/chitosan (mg) divided by that of resin alone (mg)

### Example 3

In this example chitosan was treated with a mild halogenating solution and the resulting chitosan-based material was placed in a water treatment system with an MCV iodinated anion exchange resin. The iodine and iodide values were compared with those observed with untreated chitosan and an MCV® resin without a chitosan-based material.

Trichloroisocyanuric acid (TCCA) (0.94 g) was added to mixture of deionized water (750 mL) and 22 g of chitosan in a 1 L bottle. The resulting solution was a 0.125% (wt) aqueous solution of TCCA. The resulting suspension was gently mixed or tumbled for 4 hours. The liquid was removed and the remaining solid was washed three times with 1 L volumes of deionized water. The chitosan-based material was dried under normal conditions at around 60° C. for 80 minutes in a commercial dryer.

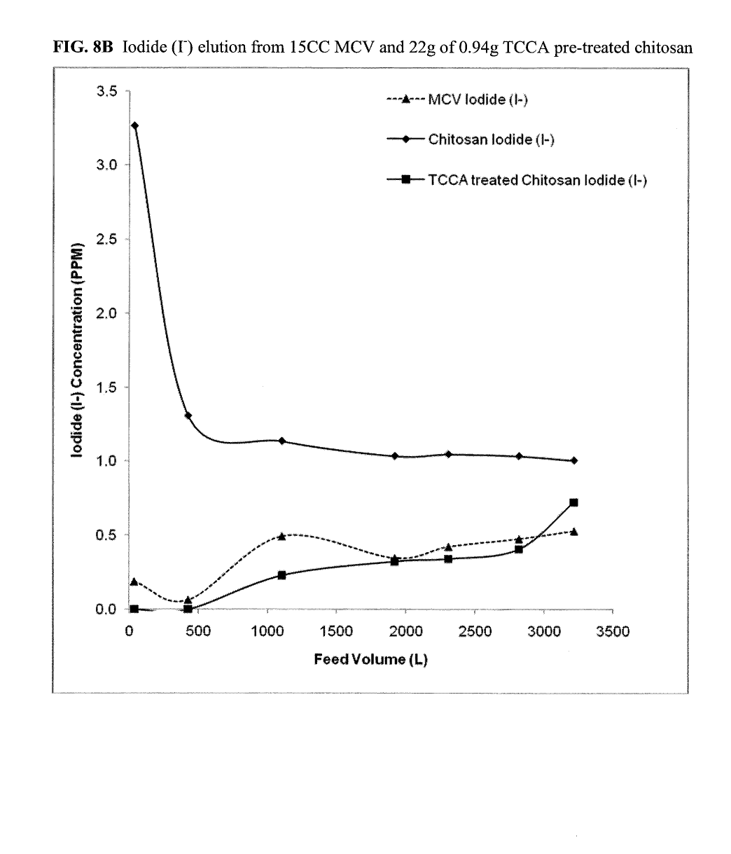

The results of an iodine (I₂)/iodide (I⁻) experiment of a water treatment system comprising i) MCV® Resin, ii) MCV® Resin and untreated chitosan and iii) MCV® Resin and the chitosan treated with TCCA are shown in FIG. 8. FIG. 8A presents the I₂ values (ppm) as a function of feed volume (L) and FIG. 8B presents the I⁻ values (ppm) as a function of feed volume (L). The volume of MCV® Resin was 15 cc, the mass of chitosan or treated chitosan was 22 grams. The flow rate was 160 mL/min. The iodine concentration was measured by the leuco-crystal violet method 4500-I B and the iodide concentration was measured by the leuco-crystal violet method 4500-I⁻ B as described in “Standard Methods for the Examination of Water and Wastewater”, American Water Works Association, 21^{st} edition (2005), pp. 4-95 and 4-98.

### Example 4

In this example chitosan was treated with a mild halogenating solution and the resulting chitosan-based material was placed in a water treatment system with an MCV® iodinated anion exchange resin. The iodine and iodide values were compared with those observed with untreated chitosan and an MCV resin without a chitosan-based material.

Iodine crystal (1.0 g) was added to mixture of deionized water (750 mL) and 22 g of chitosan in a 1 L bottle. The resulting suspension was gently mixed or tumbled for overnight (12-16 hours). The liquid was removed and the remaining solid was washed three times with 1 L volumes of deionized water. The chitosan-based material was dried under normal conditions at around 60° C. for 80 minutes in a commercial dryer.

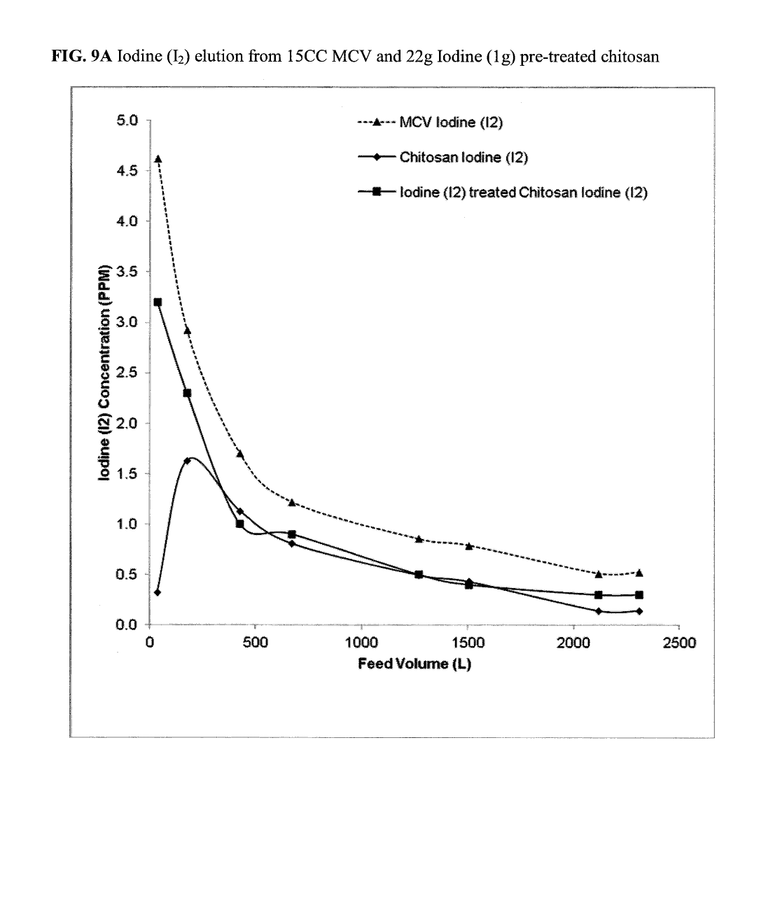

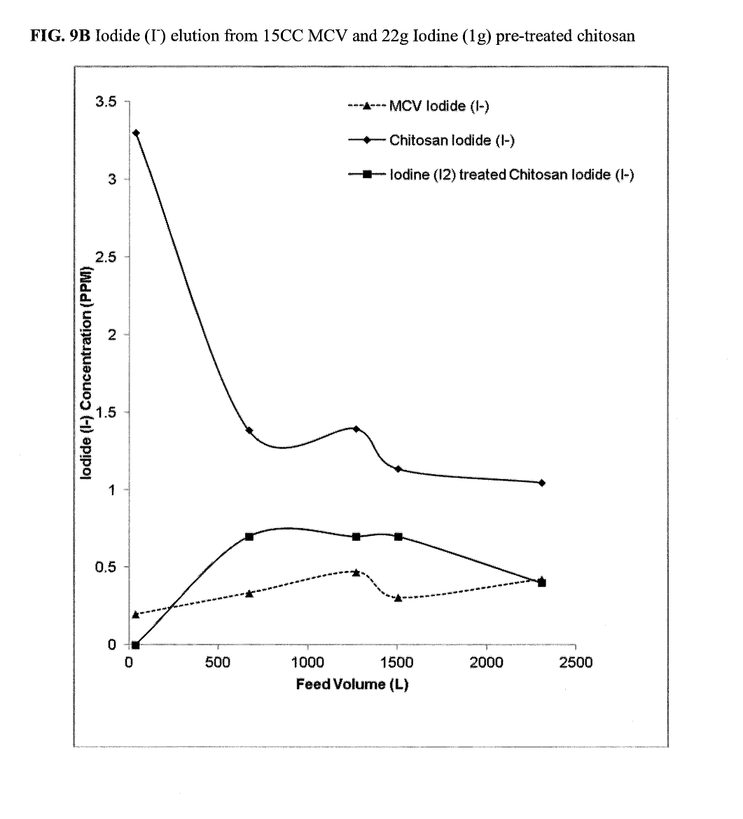

The results of an iodine (I₂)/iodide (I⁻) experiment of a water treatment system comprising i) MCV® Resin, ii) MCV® Resin and untreated chitosan and iii) MCV® Resin and the chitosan treated with iodine solution are shown in FIG. 9. FIG. 9A presents I₂ values (ppm) as a function of feed volume (L) and FIG. 9B presents I⁻ values (ppm) as a function of feed volume (L). The volume of MCV® Resin was 15 cc, the mass of chitosan or treated chitosan was 22 grams. The flow rate was 160 mL/min. The iodine concentration was measured by the leuco-crystal violet method 4500-I B and the iodide concentration was measured by the leuco-crystal violet method 4500-I⁻ B as described in “Standard Methods for the Examination of Water and Wastewater”, American Water Works Association, 21^{st} edition (2005), pp. 4-95 and 4-98.

### Example 5

A challenge experiment may be used to determine the ability of a water treatment system to reduce contaminants from a fluid. A challenge, or a known quantity of a selected microbiological contaminant, may be added to the influent. The virus MS2 coliphage (ATCC 15597-B1) may be chosen as the microbiological contaminant. The amount of the contaminant in the influent and effluent may be measured to determine the filtration capacity or microbial inactivation capacity of the water treatment system.

A challenge experiment of certain embodiments of the water treatment systems described herein was compared to conventional water treatment systems comprising untreated chitosan. A Log value (Log PFU/mL) of 5 for MS2 in 3000 mL de-chlorinated tap water at room temperature was introduced to the water treatment system via the inlet and dispensed through the outlet. The influent and effluent were tested for MS2 coliphage before and after contact with the water treatment systems. The diameter of the water treatment system was 4.2 cm. The feed water flow rate was 160 mL/min. Chitosan-based material from treating chitosan with mild acid was chosen for the challenge experiment.

The results of a challenge experiment of a water treatment system comprising chitosan are shown in Table 3. The chitosan was 22 grams of industrial grade chitosan volume in water around 120 mL. The feed water volume was 640 L.

### Citric Acid (CA) Pre-Treatment:

The 22 g Chitosan mixed with 750 mL of 0.25% of CA solution (% of CA solution—1.875 g in 750 mL of DI water) tumbled for 4 h and washed with DI water and dried in a commercial dryer in a normal condition at around 60° C. for 80 minutes.

Feed water volume: 640 L—De-chlorinated tap water, Feed water Flow Rate: 160 mL/min, Challenge water was: 3000 mL (3 L) of approximately 5 log PFU/mL of MS2 in de-chlorinated tap water at room temperature (23° C.).

TABLE 3
MS2 Removal by Citric Acid (CA) Pre-treated Chitosan-Based Material
and Commercial Chitosan (Un-treated) at 640 L Feed Volume

| Treatment | MS2 Log removal (Log PFU/mL) | | | |
|---|---|---|---|---|
| Feed volume 640 L | Influent | Effluent | Individual | Cumulative |
| MCV ® (15 CC) | 5.0 | 3.2 | 1.8 | 1.8 |
| Chitosan | 3.2 | 0.5 | 2.7 | 4.5 |
| (Untreated, 22 g) | | | | |
| (Control) | | | | |
| 0.25% CA 4 h | 3.2 | 0.6 | 2.6 | 4.4 |
| Pre-treated | | | | |
| Chitosan (22 g) | | | | |

Negative controls: de-chlorinated tap water without MS2 showed no detectable plaques indicating there were no contaminations during the dis-infective assay.

All documents cited herein are incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular embodiments of water treatment systems have been illustrated and described, it would be obvious to those skilled in the art that various other changes and modifications can be made without departing from the spirit and scope of the invention. Those skilled in the art will recognize, or be able to ascertain using no more than routine experimentation, numerous equivalents to the specific apparatuses and methods described herein, including alternatives, variants, additions, deletions, modifications and substitutions. This application including the appended claims is therefore intended to cover all such changes and modifications that are within the scope of this application.

We claim:

1. A method for producing a water filtration/purification material comprising a chitosan-based product, the method comprising:
contacting chitosan or chitin with a compound selected from the group consisting of an acid, a base, a mild halogenating solution, and combinations of any thereof to provide a chitosan-based product,
wherein the chitosan-based material displays reduced conversion of halogen (X₂) to halide ion (X⁻) compared to a chitosan or chitin that has not been contacted with an acid, a base, and/or a mild halogenating solution.

2. The method of claim 1, wherein the chitosan or chitin is contacted with an acid selected from the group consisting of citric acid, oxalic acid, sulfuric acid, phosphoric acid.

3. The method of claim 2, wherein the acid comprises an aqueous solution comprising from about 0.05% to about 1.0% by weight of the acid.

4. The method of claim 2, wherein the acid comprises an aqueous solution of citric acid.

5. The method of claim 4, wherein the ratio of chitosan or chitin to acid is from about 5:1 to about 50:1.

6. The method of claim 1, wherein chitin is contacted with a base under conditions to undergo a mild deacetylation process on the chitin.

7. The method of claim 6, wherein the conditions comprise contacting the chitin with an aqueous solution of an alkali metal hydroxide having a concentration of between about 10% to about 50% by weight at a temperature of between about 80° C. and about 150° C. for from about 0.5 hr to about 10 hr.

8. The method of claim 6, wherein the chitosan-based material has from greater than 5% to 40% deacetylation.

9. The method of claim 1, wherein the chitosan or chitin is contacted in a mild halogenating process comprising from about 0.05% to about 2.0% by weight of a halogenating agent.

10. The method of claim 9, wherein the halogenating agent is selected from the group consisting of trichloroisocyanuric acid (TCCA), dichloroisocyanuric acid (DCCA), iodine crystal, a liquid halogen, a halogen gas, sodium hypochlorite, calcium hypochlorite, chlorine tablets, sodium chlorite, and combinations of any thereof.

11. The method of claim 1, wherein the method comprises contacting the chitosan or chitin with a combination of two or more of an acid treatment, a basic treatment, and a mild halogenating solution to provide a chitosan-based product.

12. The method of claim 1, further comprising washing the chitosan-based material with at least one aqueous wash.

13. The method of claim 1, wherein the chitosan-based material has a mesh size from about 5 to about 30 mesh.

14. A water treatment system for providing potable water, the system initially comprising:
an inlet in fluid communication with an outlet;
a halogen release system comprising a first halogen, wherein the halogen release system is intermediate the inlet and the outlet; and
a chitosan-based material made by a method according to claim 1, wherein the chitosan-based material is intermediate the halogen release system and the outlet.

15. The water treatment system of claim 14, wherein the halogen release system is selected from the group consisting of chlorinated anion exchange resins, iodinated anion exchange resins, brominated anion exchange resins, halogenated ion exchange resins, iodinated resins, liquid halogens, gaseous halogens, halogen crystals, halogen compounds, and combinations of any thereof.

16. The water treatment system of claim 14, wherein the water treatment system displays at least one of a reduced halogen to halide conversion and a reduced excess halide ion leakage compared to a water treatment system with a conventional chitosan material.

17. The water treatment system of claim 16, wherein water treated by the water treatment system displays a halide ion concentration of less than 3 ppm downstream from the chitosan-based material.

18. The water treatment system of claim 14, further comprising a scavenger barrier intermediate the chitosan-based material and the outlet.

19. A method for manufacturing a water treatment system comprising:
contacting chitosan or chitin with a compound selected from the group consisting of an acid, a base, a mild halogenating solution, and combinations of any thereof to provide a chitosan-based product, wherein the chitosan-based material displays reduced conversion of halogen (X₂) to halide ion (X⁻) compared to a chitosan or chitin that has not been contacted with an acid, a base, and/or a mild halogenating solution; and
positioning the chitosan-based material intermediate a halogen release system and an outlet,
wherein the halogen release system, the chitosan-based material and the outlet are in fluid communication.

20. A method for treating water comprising at least one contaminant comprising:
flowing the water sequentially through a halogen release system and a chitosan-based material produced according the method of claim 1,
wherein the water has a halide ion concentration of less than 3 ppm downstream from the chitosan-based product.

21. The method of claim 20, wherein the treated water displays a viral Log reduction value of at least 4 and a bacterial Log reduction value of at least 6 at a temperature of at least 4° C. and a pH of at least 5.
